(19) United States
(12) Patent Application Publication
(10) Pub. No.: US 2012/0161554 A1
(43) Pub. Date: Jun. 28, 2012

(54) COOLING SYSTEM FOR A HIGH DENSITY POWER MOTOR, IN PARTICULAR AN AXIAL-FLUX MOTOR

(76) Inventors: Gian Paolo Ghelardi, Novi Ligure (IT); Giancarlo Costa, Genova (IT); Giuseppe Canepa, Mele (IT); Riccardo Parenti, Pieve Ligure (IT); Claudio Mazzieri, Arquata Scrivia (IT); Adolfo Martino, Genova (IT)

(21) Appl. No.: 13/265,744

(22) PCT Filed: Apr. 21, 2010
(86) PCT No.: PCT/IB2010/000892

§ 371 Date: Mar. 2, 2012

(30) Foreign Application Priority Data
Apr. 22, 2009 (IT) TO2009A000317

(51) Int. Cl. H02K 9/19

(52) U.S. Cl. 310/54

(57) ABSTRACT

A cooling system for a high density power motor, in particular an axial-flux electric motor, wherein a pump is directly fitted in an axial position on the output shaft of the electric motor and feeds at outlet a flow of liquid coolant directed towards a first heat exchanger coupled to a power electronic supply circuit of said motor; the first heat exchanger having at least one outlet from which the liquid coolant is fed to a second heat exchanger coupled to the windings of the electric motor for cooling the electric motor itself; the cooling system carrying out in succession removal of the heat from the power electronic supply circuit and then from the electromagnetic part of the motor.

### TECHNICAL FIELD

The present invention relates to a cooling system for a high density power motor, in particular an axial-flux motor.

### BACKGROUND ART

In the prior art, the problem of cooling high density power motors, such as axial-flux motors, may be solved by resorting to forced ventilation.

In other cases, closed circuit cooling systems are used, in which a coolant liquid is circulated in a cooling circuit by an external recirculation pump actuated by an auxiliary motor.

In both cases, the operation of the electric motor cooling system requires an external energy source which moves either the air or the coolant liquid.

The cooling systems using a liquid circulated by a pump actuated by the motor, which needs to be cooled itself, has a series of problems such as:

i) the rotation speed of the motor, in many typical applications of the motor itself, is not high enough (100÷1800 rpm) to allow the use of centrifuge type pumps of size and weight compatible with the weight requirements and available spaces;

ii) the recirculation pump is a load in terms of power consumption which is taken from the motor thus reducing the efficiency of the motor itself—the circulation of coolant fluid also subtracts a portion of the power generated by the motor;

iii) problems of operation exist related to the great difference between the ideal operating temperature and the maximum temperature of the various parts of the motor (e.g. power electronic and stator windings).

### DISCLOSURE OF INVENTION

It is the object of the present invention to make a cooling system for a high density power motor, in particular an axial-flux electric motor, which solves the drawbacks of the known systems, and in particular has negligible dimensions.

The object is reached by the present invention in that it relates to a cooling system for a high density power motor, in particular an axial-flux electric motor, wherein a pump driven by the electric motor moves a coolant liquid, characterized in that said pump is directly fitted in an axial position on the output shaft of said electric motor and feeds an outlet flow of liquid coolant directed towards a first heat exchanger coupled to a power electronic supply circuit of said electric motor; said first heat exchanger having at least one outlet from which the liquid coolant is fed to a second heat exchanger coupled to the windings of the electric motor for cooling the electric motor itself; said cooling system carrying out in succession removal of the heat from the power electronic supply circuit and then from the electromagnetic part of the motor.

### BRIEF DESCRIPTION OF THE DRAWINGS

The invention will now be explained with particular reference to the accompanying drawings which show a preferred non-limitative embodiment, in which:

FIG. 1 is a diagrammatic view of a cooling system made according to the dictates of the present invention;

FIG. 2 is a perspective view of the electric motor and the cooling system;

FIG. 3 is a longitudinal section of a pump used in the cooling system of the present invention;

FIG. 4 is a cross section view of the pump in FIG. 3;

FIG. 5 is a perspective view of a detail of the pump shown in FIG. 3;

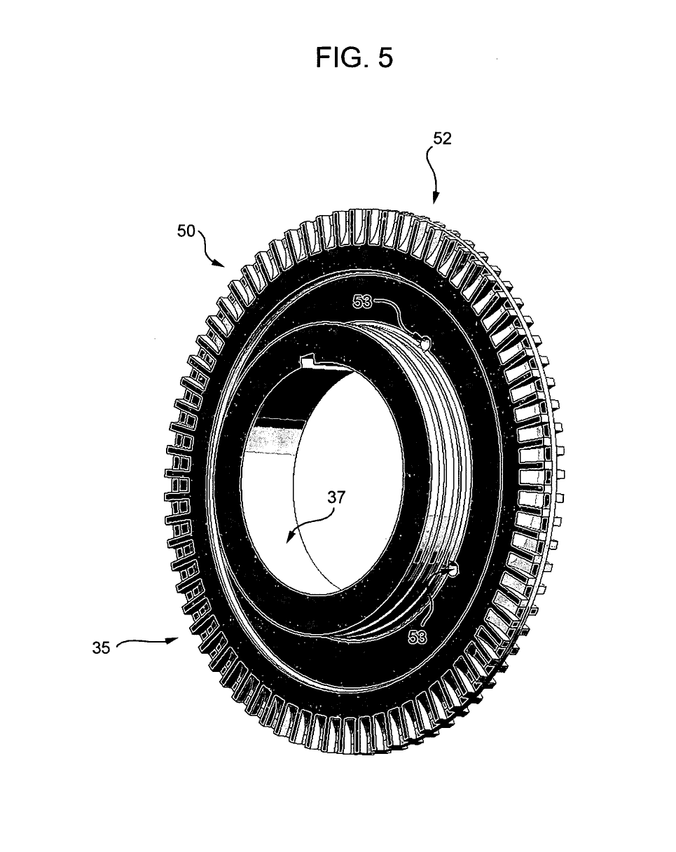

FIG. 6 is a perspective view of a section of the heat exchanger of the electromagnetic part.

### BEST MODE FOR CARRYING OUT THE INVENTION

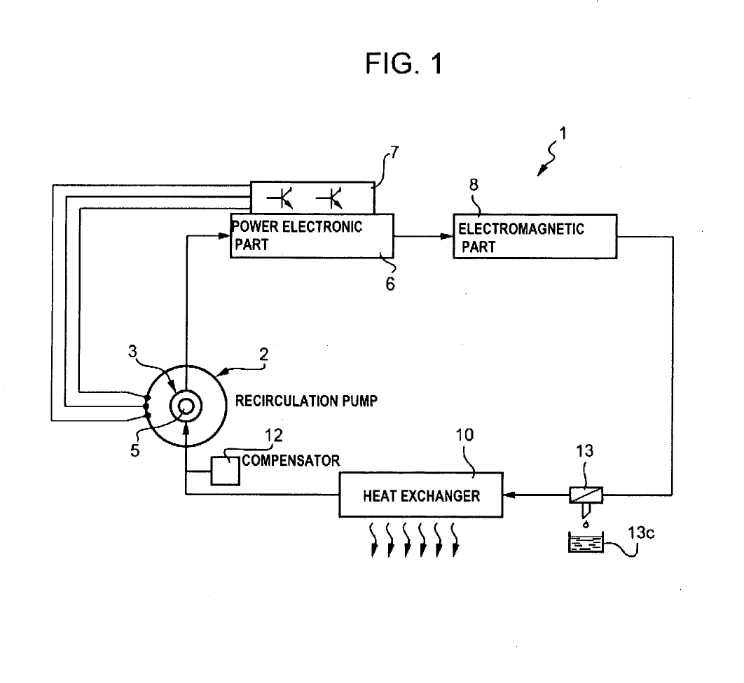

In FIG. 1, numeral 1 indicates as a whole a cooling system for a high density power motor 2, in particular an axial-flux motor (diagrammatically shown).

The system 1 is provided with a recirculation pump 3 actuated by the electric motor 2 and adapted to move a flow of coolant liquid.

Water and antifreeze additives may be used as coolant liquid. For example, a mixture of water and ANTIFROGEN KF® or MECAFLUID/P-CR® up to a concentration of 100% may be used.

According to the present invention, the pump 3 is directly fitted in an axial position on the output shaft 5 of the electric motor 2 and feeds at outlet a flow of liquid coolant directed towards a first heat exchanger 6 coupled to a power electronic supply circuit 7 of the electric motor 2.

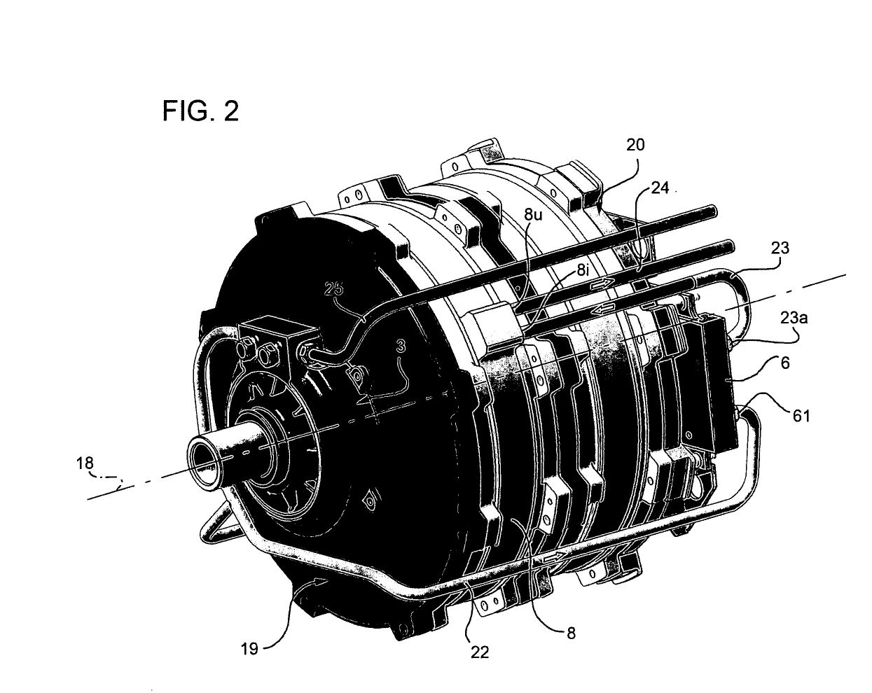

The first heat exchanger 6, of known type, may consist of a flat metallic plate 6p (e.g. a rectangular-shaped aluminum plate, partially shown in FIG. 2), within which a plurality of serpentines (not shown) in which coolant liquid runs are formed. The power components (electronic switches, e.g. IGBT) may be directly mounted with the heat sinks thereof (not shown) in contact on the flat surface of the metallic plate 6p, e.g. using screws (not shown) screwed into holes (not shown) of the metallic plate.

The first heat exchanger 6 has at least one outlet from which the liquid coolant is fed to a second heat exchanger 8 coupled to the windings of the electric motor 2 for cooling inside of the electric motor 2.

In this manner, the cooling system 1 in sequence removes heat from the power electronic supply circuit 7 and then from the electromagnetic part of the motor 2. The heat is removed from the electromagnetic part of the motor 2 using a liquid which has a temperature higher than that at the inlet of the first heat exchanger 6.

The removal of heat from the joints of the power semiconductors (e.g. the IGBT) in the power electronic supply circuit 7, which must work at temperatures under a given threshold, e.g. 125° C., is thus guaranteed.

Although the coolant liquid has a temperature higher at the outlet from the first heat exchanger 6, this temperature is in all cases sufficient to guarantee a heat exchange within the second heat exchanger 8 by cooling down the windings of the electric circuit 2.

Typical values of the temperatures of the electric windings in continuous operation for class H insulation are about 180° C.

If the cooling of the power electronic circuit 7 occurred at higher exchanger temperature instead, there would be no operating margin for managing thermal jumps within the joint-exchanger change, with disastrous effects.

The system 1 is further provided with a third heat exchanger (10) (of known type and therefore not illustrated) set between an outlet of the second heat exchanger 8 and an inlet of the recirculation pump 3 to dissipate the heat present in the coolant liquid towards the outside of the motor, carrying out cooling of the liquid coolant towards the inlet of the recirculation pump 3.

Finally, a volume compensator 12 is provided, adapted to absorb the variations of volume of the coolant liquid between a low-temperature rest state (e.g. 0° C.) and an operating state (e.g. 70° C.) in which the temperature is higher.

The tubes (not shown for the sake of simplicity in FIG. 1, of diagrammatic type) are made of material with a very low inner roughness so as to maintain fluid circulation mainly laminar at the concerned flow rates and to limit pressure drops in the tubes themselves.

The cooling system 1 is provided with a controlled-failure fusible area 13 is provided, which, in the case of pressure of the liquid coolant higher than a limit value, enables to discharge of part of the liquid towards a collection area 13c in order to reduce such pressure.

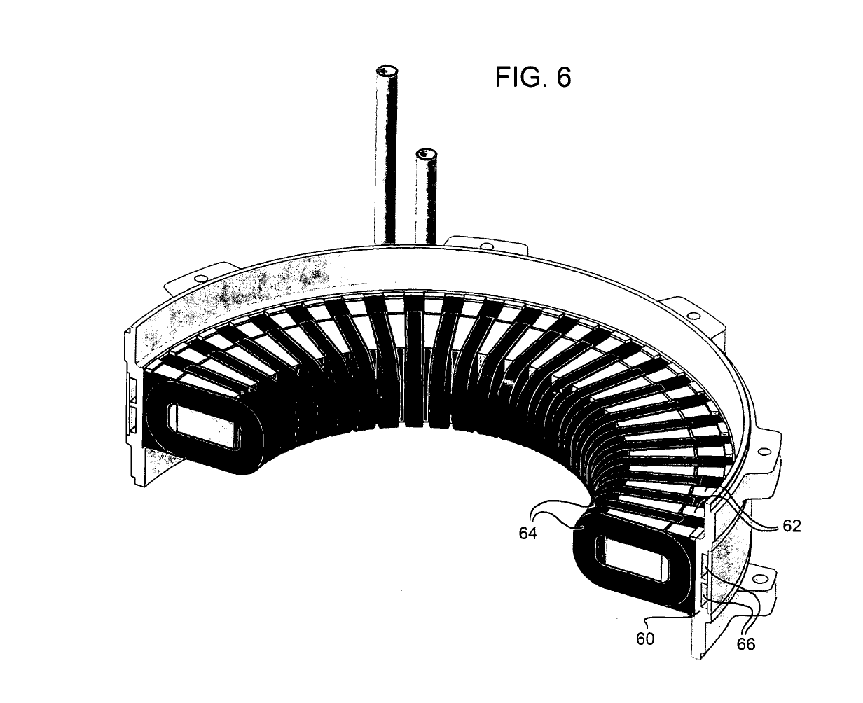

Typically (FIG. 6), the second heat exchanger 8 comprises a metallic ring 60 provided with a plurality of teeth 62 integral with the ring 60 and extending towards the inside of the ring itself; each tooth is adapted to be interposed between two windings 64 of the axial flux motor 2 arranged side by side which extend in radial direction from a toroidal core of the motor stator. The metallic ring has a plurality of inner channels 66, within which the coolant liquid flows (FIG. 6).

FIG. 2 shows a perspective view of the electric motor 2 and the cooling system 1.

The motor 2 (of known type) has an outer shape that is substantially cylindrical with axis 18 and is delimited, on opposite sides, by a plane front wall 19 and by a plane rear wall 20, both perpendicular to the axis 18.

The recirculation pump 3 is set on the front wall 19 and is coaxial with axis 18, whilst the first heat exchanger 6 is mounted on the rear wall 20.

FIG. 2 shows:
a first tube 22 which extends from the outlet of the pump 3 to an inlet 6i of the first heat exchanger 6 to carry a coolant liquid flow from the pump 3 to the first heat exchanger 6;
a second tube 23 which extends from an outlet 23u of the first heat exchanger 6 to an inlet 8i of the second heat exchanger 8 to obtain a coolant liquid flow from the first heat exchanger 6 to the second one 8;
a third tube 24 which extends from an outlet 8u of the second heat exchanger 8 to an input of the third heat exchanger 19 (not shown in FIG. 2) to obtain a flow of coolant liquid from the second heat exchanger 8 to the third one 10; and
a fourth tube 25 which connects the outlet of the third heat exchanger (not shown in FIG. 2) with the inlet of the pump 3.

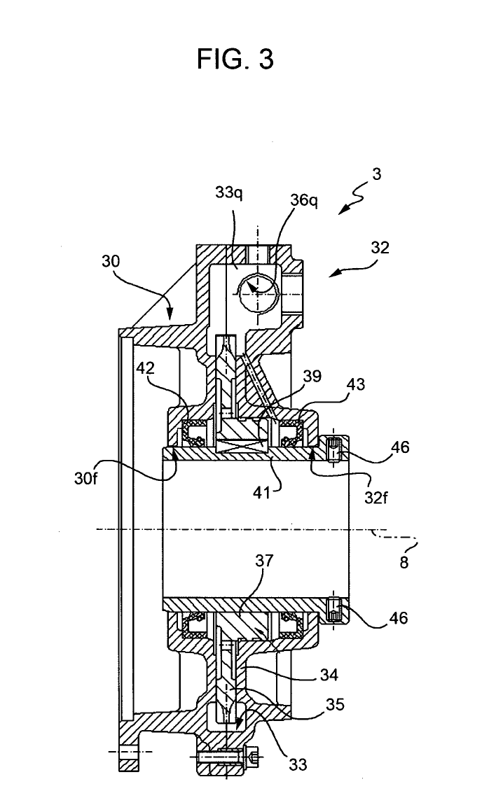

FIG. 3 shows the detail of the recirculation pump 3 (of the liquid ring or side liquid channel type) which comprises:
a first half casing 30 stably mountable on the front wall 19;
a second half casing 32 perimetrally coupled to the first half casing 30 and defining therewith a cylindrical inner chamber 33 accommodating an impeller 34.

The half casings 30,32 have through central openings 30f, 32f having the same diameter and coaxial to axis 8. The half casings 30, 32 are typically made of aluminum alloy.

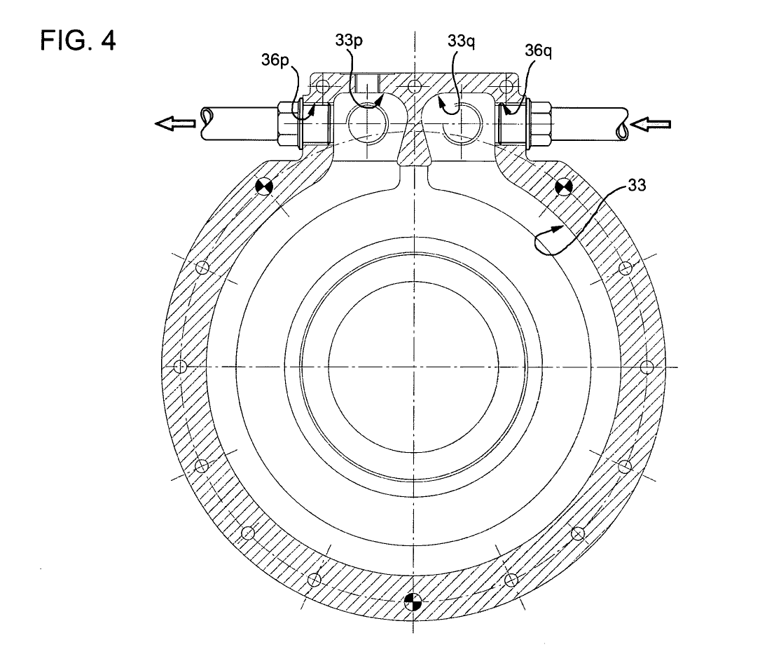

The cylindrical chamber 33 (FIG. 4) communicates laterally in radial direction with a first and a second perimetral chamber 33p, 33q arranged side by side; each perimetral chamber 33p, 33q has an approximately parallelepiped shape and is delimited by facing positions of the first and the second half casing 30,32.

The first chamber 33p and the second chamber 33q are reciprocally separated by a partition 31 made by portions of the half casings 30 and 32 arranged side by side.

A hole 36q is made in a wall delimiting the second chamber 33q; such a hole 36q defines an inlet of the recirculation pump 3 communicating with the fourth tube 25. In this manner, the chamber 33q forms an intake chamber.

A hole 36p is made in a wall delimiting the first chamber 33p; such a hole 36p defines an outlet of the recirculation pump 3 communicating with the tube 22. In this manner, the chamber 33p forms a delivery chamber.

The impeller 34 (FIG. 4) comprises a disk-shaped body 35 integral with a short tubular portion 37 perpendicular to the disk-shaped body 35 and coaxial to axis 8.

The impeller 34 is also made of aluminum and subjected to a hardening process. The impeller 34 may also be made of bronze or plastic material of adequate hardness.

The tubular portion 37 is mounted in axial, angularly stable manner (by means of a tongue 39) on a cylindrical tube 41 coaxial to axis 8 and directly engaging (i.e. without the interposition of bearings) the two central openings 30f, 32f. With this regard, the cylindrical tube 41 has a diameter slightly smaller to that of the through central openings 30f, 32f.

The fluid-tightness of the tube 41 with the first and second half casing 30, 32 is ensured by means of annular seals 42, 43 coupled to an inner portion of the first/second half casing 30,32 and the tube 41, respectively.

The cylindrical tube 41 accommodates the outlet shaft 5 of the electric motor 2, which is fixedly connectable to the tube 41 by means of one or more screws 46.

The disk-shaped body 35 defines on a first face thereof a first array (e.g. 48-72) of first perimetral radial blades 50 with a rectangular cross section and defines on a second face opposite to the first an array of second perimetral radial blades 52 with a rectangular cross section.

The first and the second array of blades 50, 52 are angularly staggered with respect to one another by half a blade pitch.

The disk-shaped body 35 has a plurality of through holes 53 extending in axial direction and made in proximity of the tubular portion 37; such through holes 53 are made to equalize the pressure within the cylindrical chamber 33 preventing the fluid arranged between the opposite parts of the disk-shaped body 35 from having different pressures.

The coolant liquid circulates in part in the gaps between the blades 50 and 52 and in part in the cylindrical chamber 33 thus forming a peripherical operating pump.

Furthermore, a pressure leveling system within the pump is provided in which a compensation hole 54 made in the second half casing 32 puts the intake chamber 33q into communication with the portion of the tube 41 in proximity to the sealing zone (sealing rings 42, 43) making it possible to use sealing rings made of elastomer instead of costly, cumbersome mechanical seals. In this manner, the relatively low pressure in the suction chamber 33q is “transferred” into the portion of the tube 41 close to the sealing zone.

The pump 3 described above allows the direct fitting onto the shaft 5 of the motor 2, allows not to use bearings for the impeller 34 of the pump, guarantees high reliability and does not need lubrication.

By way of example, the pump 3 may have the following features:

| RPM | 0-1800 | |
|---|---|---|
| Flow rate | 0-50 | l/m |
| Operative pressure | 3-8 | bars |
| Fluid temperature (inlet) | max. 70° | C. |
| Weight | 2.40 | kg |

1. A cooling system for a high density power motor, in particular an axial-flux motor, wherein a pump driven by the motor moves a liquid coolant, said system being characterized in that said pump (3) is directly fitted in an axial position on the output shaft (5) of said motor and feeds at outlet a flow of liquid coolant directed towards a first heat exchanger (6) coupled to a power electronic supply circuit (7) of said motor; said first heat exchanger (6) having at least one outlet from which the liquid coolant is fed to a second heat exchanger (8) coupled to the windings of the motor for cooling the motor itself; said cooling system carrying out in succession removal of the heat from the power electronic supply circuit (7) and then from the electromagnetic part of the motor.

2. The system according to claim 1, wherein a third heat exchanger (10) is provided, which is set between an outlet of the second heat exchanger (8) and the inlet of the recirculation pump (3) and is designed to dissipate the heat present in the liquid coolant towards the outside of the motor carrying out cooling of the liquid coolant towards the inlet of the recirculation pump.

3. The system according to claim 1, wherein a volume compensator (12) is provided, designed to absorb the variations of volume of the liquid coolant between a low-temperature state and an operating state in which the temperature is higher.

4. The system according to claim 1, wherein a controlled-failure fusible area (13) is provided, which, in the case of pressure of the liquid coolant higher than a limit value, enables discharge of part of the liquid towards a collection area in order to reduce said pressure.

5. The system according to claim 1, wherein the motor (2) has an outer shape that is substantially cylindrical with axis (18) and is delimited, on opposite sides, by a plane front wall (19) and by a plane rear wall (20), which are both transverse to the axis (18);
said recirculation pump (3) is set on said front wall (19) and shares the axis (18) whilst the first heat exchanger (6) is mounted on the rear wall (20).

6. The system according to claim 1, wherein the pump comprises an outer casing (30, 32), which delimits inside an internal cylindrical chamber (33) housing an impeller (34);
said impeller (34) being at least angularly fixed (39) with respect to a cylindrical tube (41) sharing the axis (18) of the motor and engaging in a fluid-tight way without interposition of bearings two central openings (30f, 32f) of the casing, which share said axis (18).

7. The system according to claim 6, wherein said impeller comprises a disk-shaped body (35), which defines on a first face of its own a first array of first perimetral radial blades (50) and on a second face of its own opposite to the first a second array of second perimetral radial blades (52).

8. The system according to claim 7, wherein said first and second blades have a rectangular cross section.

9. The system according to claim 7, wherein the first and second arrays of blades (50, 52) are angularly staggered with respect to one another by a fraction of blade pitch.

10. The system according to claim 7, wherein said disk-shaped body (35) has a plurality of through holes (53) which extend in an axial direction; said holes (53) being designed to equalize the pressure inside the cylindrical chamber (33) preventing the fluid present on opposite sides of the disk-shaped body (35) from possibly having different pressures.

11. The system according to claim 6, wherein a system for levelling the pressure inside the pump is provided, in which a compensation hole (54) made in the body of the casing (32) sets in communication an intake area of the pump (33q), communicating with said cylindrical chamber (33), with the portion of the tube (41) close to the area of fluid-tight seal between the tube and the casing.

12. The system according to claim 1, wherein the liquid coolant comprises a mixture of water and antifreeze additives and has a high thermal conductivity.
